(19) United States
(12) Patent Application Publication
(10) Pub. No.: US 2018/0086954 A1
(43) Pub. Date: Mar. 29, 2018

(54) FILLER-CONTAINING PRESSURE-SENSITIVE ADHESIVE TAPE AND METHOD OF PRODUCING FILLER-CONTAINING PRESSURE-SENSITIVE ADHESIVE TAPE

(71) Applicant: NITTO DENKO CORPORATION, Osaka (JP)

(72) Inventors: Ryo MORIOKA, Ibaraki-shi (JP); Akira HIRAO, Ibaraki-shi (JP); Mitsuhiro KANADA, Ibaraki-shi (JP)

(21) Appl. No.: 15/705,470

(22) Filed: Sep. 15, 2017

(30) Foreign Application Priority Data
Sep. 29, 2016 (JP) 2016-191602

(51) Int. Cl. C09J 133/08; C09J 9/02; C09J 11/04

(52) U.S. Cl. CPC C09J 133/08; C09J 11/04; C09J 9/02

(57) ABSTRACT

Provided is a filler-containing pressure-sensitive adhesive tape having an excellent pressure-sensitive adhesive strength while suppressing the occurrence of a volatile component. The filler-containing pressure-sensitive adhesive tape includes a pressure-sensitive adhesive layer containing a pressure-sensitive adhesive resin containing an acrylic polymer and a filler dispersed in the pressure-sensitive adhesive resin, in which the acrylic polymer contains at least a constituent unit derived from a (meth)acrylic acid alkyl ester having a linear or branched alkyl group having 1 to 20 carbon atoms, a constituent unit derived from a nitrogen-containing monomer, and a constituent unit derived from a carboxyl group-containing monomer, and has a ratio (mass ratio) of the constituent unit derived from the carboxyl group-containing monomer to the constituent unit derived from the nitrogen-containing monomer of from 0.01 to 40.

This application claims priority under 35 U.S.C. Section 119 to Japanese Patent Application No. 2016-191602 filed on Sep. 29, 2016, which is herein incorporated by references.

### BACKGROUND OF THE INVENTION

### 1. Field of the Invention

The present invention relates to a filler-containing pressure-sensitive adhesive tape and a method of producing a filler-containing pressure-sensitive adhesive tape.

### 2. Description of the Related Art

There has been known a filler-containing pressure-sensitive adhesive tape including a pressure-sensitive adhesive layer having added thereto a filler for expressing various functions. The filler-containing pressure-sensitive adhesive tape has been widely used in various technical fields because of, for example, the following reasons. The tape is easily processed into a predetermined shape by punching or the like, and is easy to handle. Such pressure-sensitive adhesive tape is, for example, a conductive pressure-sensitive adhesive tape including a pressure-sensitive adhesive layer having added thereto conductive particles (see, for example, Japanese Patent Application Laid-open No. 2015-127392).

The pressure-sensitive adhesive layer of the filler-containing pressure-sensitive adhesive tape typically contains a polymer having a pressure-sensitive adhesive property (pressure-sensitive adhesive resin) as a main component. The polymer forming the pressure-sensitive adhesive layer is polymerized by using a known polymerization method, such as solution polymerization involving utilizing a monomer solution containing a monomer and a solvent, or thermal polymerization or photopolymerization involving utilizing a monomer composition liquid free of any solvent.

The solvent used in the polymerization of the polymer or an unreacted monomer may typically remain in the pressure-sensitive adhesive layer to some extent. For example, when the polymer forming the pressure-sensitive adhesive layer is polymerized by utilizing a photopolymerization initiator or a thermal polymerization initiator, the following problems may occur: applied light is blocked by the filler and hence the light hardly reaches the inside of the pressure-sensitive adhesive layer; or heat does not uniformly spread through the layer in the case of insufficient dispersion of the filler. Accordingly, a polymerization reaction hardly advances in the pressure-sensitive adhesive layer and hence the unreacted monomer is liable to remain.

Such remaining components are so-called volatile organic compounds (VOCs), and are gradually released from the pressure-sensitive adhesive layer to the air at the time of, for example, the storage or use of the pressure-sensitive adhesive tape. Accordingly, a volatilized remaining component may be responsible for an environmental load or the deterioration of a working environment. In addition, some kinds of volatile components in the pressure-sensitive adhesive layer corrode a member around the pressure-sensitive adhesive tape (e.g., the wiring portion of a circuit board) to cause the malfunction of equipment. In view of such circumstances and the like, a reduction in amount of a volatile component to be released from the pressure-sensitive adhesive layer has been required in recent years.

In addition, it is difficult to secure a pressure-sensitive adhesive strength required of the pressure-sensitive adhesive layer while reducing the amount of such volatile components in the pressure-sensitive adhesive layer, and the difficulty has been perceived as a problem.

### SUMMARY OF THE INVENTION

An object of the present invention is to provide, for example, a filler-containing pressure-sensitive adhesive tape having an excellent pressure-sensitive adhesive strength while suppressing the occurrence of a volatile component.

The inventors of the present invention have made extensive investigations to achieve the object, and have found that a filler-containing pressure-sensitive adhesive tape, including a pressure-sensitive adhesive layer containing a pressure-sensitive adhesive resin containing an acrylic polymer and a filler dispersed in the pressure-sensitive adhesive resin, in which the acrylic polymer contains at least a constituent unit derived from a (meth)acrylic acid alkyl ester having a linear or branched alkyl group having 1 to 20 carbon atoms, a constituent unit derived from a nitrogen-containing monomer, and a constituent unit derived from a carboxyl group-containing monomer, and has a ratio (mass ratio) of the constituent unit derived from the carboxyl group-containing monomer to the constituent unit derived from the nitrogen-containing monomer of from 0.01 to 40, has an excellent pressure-sensitive adhesive strength while suppressing the occurrence of a volatile component. Thus, the inventors have completed the present invention.

In the filler-containing pressure-sensitive adhesive tape, it is preferred that the acrylic polymer contain 1 mass % or more and 50 mass % or less of the constituent unit derived from the nitrogen-containing monomer.

In the filler-containing pressure-sensitive adhesive tape, it is preferred that a blending ratio (mass ratio) of the filler to the pressure-sensitive adhesive resin be from 0.1 to 3.

In the filler-containing pressure-sensitive adhesive tape, it is preferred that a volume fraction (vol %) of the filler in the pressure-sensitive adhesive layer be from 10 vol % to 70 vol %.

In the filler-containing pressure-sensitive adhesive tape, it is preferred that the filler have an average particle diameter of from 1 μm to 200 μm.

In the filler-containing pressure-sensitive adhesive tape, it is preferred that the pressure-sensitive adhesive layer have a thickness of from 5 μm to 200 μm.

In the filler-containing pressure-sensitive adhesive tape, it is preferred that the acrylic polymer have a first acrylic polymer containing at least the constituent unit derived from the (meth)acrylic acid alkyl ester and the constituent unit derived from the nitrogen-containing monomer, and a second acrylic polymer containing at least the constituent unit derived from the (meth)acrylic acid alkyl ester, the constituent unit derived from the nitrogen-containing monomer, and the constituent unit derived from the carboxyl group-containing monomer.

In the filler-containing pressure-sensitive adhesive tape, it is preferred that the second acrylic polymer contain a constituent unit derived from a polyfunctional monomer having two or more polymerizable functional groups.

In the filler-containing pressure-sensitive adhesive tape, it is preferred that the filler include conductive particles.

According to another embodiment of the present invention, there is provided a method of producing the filler-containing pressure-sensitive adhesive tape of any one of the foregoing, the method including a polymerization step of irradiating a composition, which contains at least a (meth)acrylic acid alkyl ester having a linear or branched alkyl group having 1 to 20 carbon atoms, a nitrogen-containing monomer, a carboxyl group-containing monomer, a filler, and a photopolymerization initiator, with light to provide such a pressure-sensitive adhesive layer that the filler is dispersed in a pressure-sensitive adhesive resin containing an acrylic polymer obtained by polymerization of the composition through the irradiation, in which in the polymerization step, a blending ratio (mass ratio) of the carboxyl group-containing monomer in the composition is from 0.01 to 40 with respect to a total amount of the nitrogen-containing monomer.

In the method of producing the filler-containing pressure-sensitive adhesive tape, it is preferred that: the polymerization step include a first polymerization step of irradiating a monomer composition, which contains at least the (meth)acrylic acid alkyl ester, the nitrogen-containing monomer, and the photopolymerization initiator, with light to provide a syrupy monomer composition containing a first acrylic polymer obtained by polymerization of part of the monomer composition through the irradiation, and a second polymerization step of irradiating a pressure-sensitive adhesive composition, which contains at least the syrupy monomer composition after the first polymerization step, the carboxyl group-containing monomer, the filler, and a polyfunctional monomer, with light to provide a second acrylic polymer obtained by polymerization of at least the (meth)acrylic acid alkyl ester, the nitrogen-containing monomer, and the carboxyl group-containing monomer through the irradiation, and to provide such a pressure-sensitive adhesive layer that the filler is dispersed in a pressure-sensitive adhesive resin containing the first acrylic polymer and the second acrylic polymer; and in the second polymerization step, a blending ratio (mass ratio) of the carboxyl group-containing monomer in the pressure-sensitive adhesive composition be from 0.01 to 40 with respect to a total amount of the nitrogen-containing monomer utilized in the polymerization of the first acrylic polymer and the polymerization of the second acrylic polymer.

According to the present invention, for example, the filler-containing pressure-sensitive adhesive tape having an excellent pressure-sensitive adhesive strength while suppressing the occurrence of a volatile component can be provided.

### BRIEF DESCRIPTION OF THE DRAWINGS

FIG. 1 is a schematic view of a pressure-sensitive adhesive tape formed only of a pressure-sensitive adhesive layer.

FIG. 2 is a schematic view of a pressure-sensitive adhesive tape in which a pressure-sensitive adhesive layer is formed on each of both surfaces of a base material.

FIG. 3 is a schematic view of a pressure-sensitive adhesive tape in which a pressure-sensitive adhesive layer is formed on one surface of a base material.

FIG. 4 is an explanatory view for schematically illustrating a sectional SEM image of a filler to be used in the calculation of the true density of the filler.

FIG. 5 is an explanatory view for schematically illustrating a method of measuring a resistance value (Z-axis direction).

FIG. 6 is an explanatory view for schematically illustrating a method of measuring a resistance value (X- and Y-axis directions).

### DESCRIPTION OF THE EMBODIMENTS

A filler-containing pressure-sensitive adhesive tape (hereinafter sometimes simply referred to as “pressure-sensitive adhesive tape”) according to this embodiment includes a pressure-sensitive adhesive layer containing a pressure-sensitive adhesive resin containing an acrylic polymer and a filler dispersed in the pressure-sensitive adhesive resin.

Although the “pressure-sensitive adhesive tape” is generally called by a different name, such as “pressure-sensitive adhesive sheet” or “pressure-sensitive adhesive film,” in some cases, the unified expression “pressure-sensitive adhesive tape” is used herein. In addition, a surface of a pressure-sensitive adhesive layer in a pressure-sensitive adhesive tape is sometimes referred to as “pressure-sensitive adhesive surface.”

The pressure-sensitive adhesive tape of this embodiment may be a double-sided pressure-sensitive adhesive tape in which both surfaces of the tape serve as pressure-sensitive adhesive surfaces, or may be a single-sided pressure-sensitive adhesive tape in which only one surface of the tape serves as a pressure-sensitive adhesive surface.

The double-sided pressure-sensitive adhesive tape may be a so-called base material-less double-sided pressure-sensitive adhesive tape that does not include a base material, such as a metal foil, or may be a so-called double-sided pressure-sensitive adhesive tape with a base material that includes the base material.

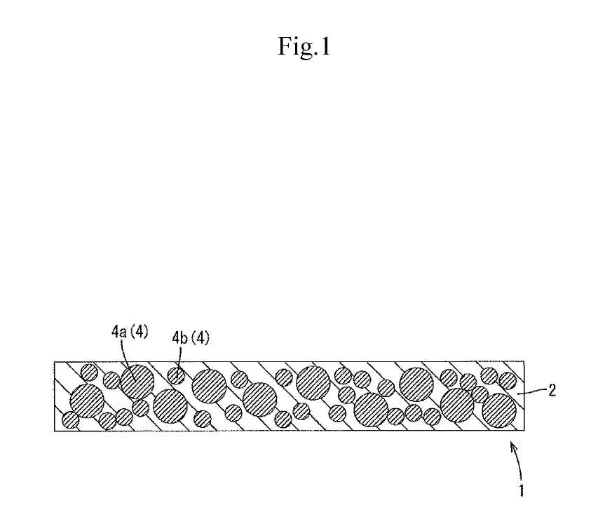

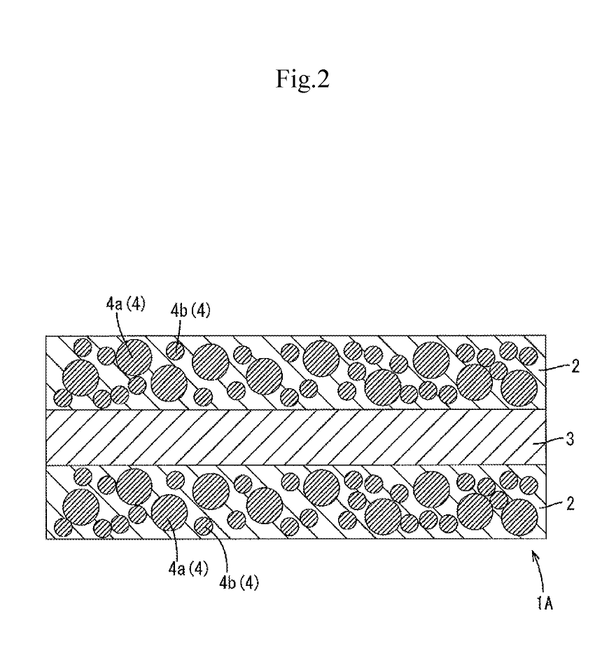

The base material-less double-sided pressure-sensitive adhesive tape is, for example, a pressure-sensitive adhesive tape formed only of a pressure-sensitive adhesive layer 2 as illustrated in FIG. 1. In contrast, the double-sided pressure-sensitive adhesive tape with a base material is, for example, a pressure-sensitive adhesive tape 1A in which the pressure-sensitive adhesive layer 2 is formed on each of both surfaces of a base material 3 as illustrated in FIG. 2.

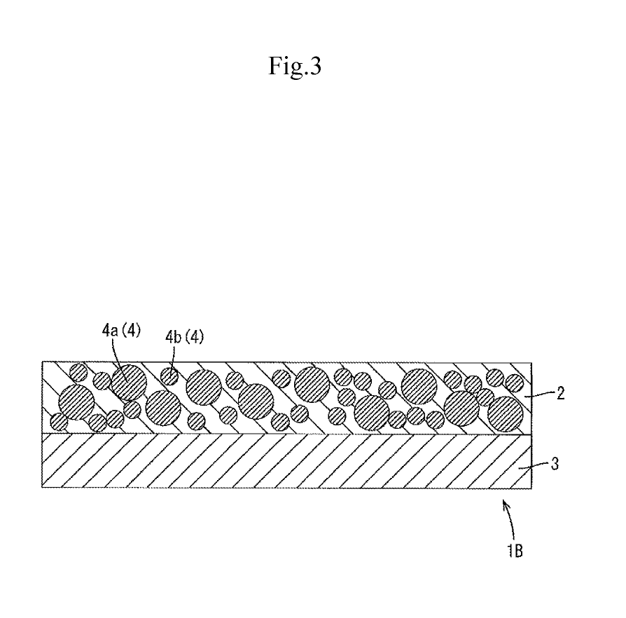

In addition, the single-sided pressure-sensitive adhesive tape is, for example, a pressure-sensitive adhesive tape 1B in which the pressure-sensitive adhesive layer 2 is formed on one surface of the base material 3, such as a metal foil, as illustrated in FIG. 3. In each of FIGS. 1 to 3, a filler 4 (a large-diameter filler 4a and a small-diameter filler 4b) in the pressure-sensitive adhesive layer 2 is schematically illustrated.

The pressure-sensitive adhesive tape of this embodiment may include any other layer (e.g., an intermediate layer or an undercoat layer) in addition to the base material and the pressure-sensitive adhesive layer to the extent that the object of the present invention is not impaired.

[Pressure-Sensitive Adhesive Layer]

The pressure-sensitive adhesive layer is a layer having functions, such as conductivity (electrical conductivity), while providing a pressure-sensitive adhesive surface of the pressure-sensitive adhesive tape. For example, when the pressure-sensitive adhesive layer has conductivity, the bonding of the pressure-sensitive adhesive surface of the pressure-sensitive adhesive layer to an adherend, such as a conductor, secures electrical conduction between the adherend and the pressure-sensitive adhesive layer.

The pressure-sensitive adhesive layer contains at least the pressure-sensitive adhesive resin and the filler. The pressure-sensitive adhesive layer may contain any other component (additive) to the extent that the object of the present invention is not impaired.

(Pressure-Sensitive Adhesive Resin)

The pressure-sensitive adhesive resin is a component for, for example, securing the pressure-sensitive adhesive strength of the pressure-sensitive adhesive layer. Examples of the pressure-sensitive adhesive resin to be used in the pressure-sensitive adhesive layer include an acrylic polymer, a silicone-based polymer, a urethane-based polymer, and a rubber-based polymer. Of those, an acrylic polymer is preferably used from the viewpoints of, for example, the ease with which the polymer is designed, the ease with which the pressure-sensitive adhesive strength is adjusted, and the securement of the dispersibility of the filler (e.g., conductive particles). As described later, the acrylic polymer contains a first acrylic polymer and a second acrylic polymer. The pressure-sensitive adhesive layer preferably contains a mixture of the first acrylic polymer and the second acrylic polymer.

The content of the pressure-sensitive adhesive resin is preferably 20 mass % or more, more preferably 25 mass % or more, still more preferably 30 mass % or more with respect to the total mass (100 mass %) of the pressure-sensitive adhesive layer, and is preferably 60 mass % or less, more preferably 55 mass % or less with respect thereto.

In addition, the content of the acrylic polymer is preferably 80 mass % or more, more preferably 85 mass % or more with respect to the total mass (100 mass %) of the pressure-sensitive adhesive resin, and is preferably 100 mass % or less, more preferably 90 mass % or less with respect thereto.

The first acrylic polymer contains at least a constituent unit derived from a (meth)acrylic acid alkyl ester having a linear or branched alkyl group having 1 to 20 carbon atoms (hereinafter simply referred to as “ (meth)acrylic acid alkyl ester”) and a constituent unit derived from a nitrogen-containing monomer. The term “(meth)acrylic” as used herein refers to “acrylic” and/or “methacrylic” (one or both of “acrylic” and “methacrylic”).

Examples of the (meth) acrylic acid alkyl ester include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth) acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, t-pentyl (meth)acrylate, neopentyl (meth)acrylate, isohexyl (meth)acrylate, isoheptyl (meth)acrylate, 2-propylheptyl (meth)acrylate, isoundecyl (meth)acrylate, isododecyl (meth)acrylate, isomyristyl (meth)acrylate, isopentadecyl (meth)acrylate, isohexadecyl (meth)acrylate, isoheptadecyl (meth)acrylate, and isostearyl (meth)acrylate. Such (meth)acrylic acid alkyl esters may be used alone or in combination thereof.

The (meth)acrylic acid alkyl ester is preferably a (meth)acrylic acid alkyl ester having an alkyl group having 4 to 12 carbon atoms, more preferably a (meth)acrylic acid alkyl ester having an alkyl group having 4 to 8 carbon atoms, from the viewpoints of a pressure-sensitive adhesive strength, a cohesive strength, and the like. Preferred specific examples thereof include n-butyl (meth)acrylate and 2-ethylhexyl (meth)acrylate.

The nitrogen-containing monomer can improve the cohesive strength of the acrylic polymer through copolymerization with the (meth)acrylic acid alkyl ester.

A compound (N-vinyl compound) that contains a nitrogen atom and contains a structure in which a vinyl group is directly bonded to the nitrogen atom is utilized as such nitrogen-containing monomer. Specific examples of the nitrogen-containing monomer include N-vinyl-2-pyrrolidone (NVP), N-vinyl-ε-caprolactam (NVC), N-vinylpiperidone (1-vinylpiperidin-2-one), N-vinyl-3,5-morpholinedione (4-vinyl-3,5-morpholinedione), N-vinyl-3-morpholinone (4-vinyl-3-morpholinone), N-vinyl-1,3-oxazin-2-one (tetrahydro-3-vinyl-2H-1,3-oxazin-2-one), N-vinylformamide, N-methyl-N-vinylformamide, N-vinylacetamide, and N-methyl-N-vinylacetamide. Those nitrogen-containing monomers may be used alone or in combination thereof.

The nitrogen-containing monomer is preferably a compound containing a structure in which a carbonyl group is further directly bonded to a nitrogen atom having directly bonded thereto a vinyl group, and is particularly preferably a compound containing a heterocyclic structure.

The nitrogen-containing monomer is preferably N-vinyl-2-pyrrolidone (NVP) or N-vinyl-ε-caprolactam (NVC), particularly preferably N-vinyl-2-pyrrolidone (NVP).

The nitrogen-containing monomer has the following property: its reactivity with a radical generated from a polymerization initiator (e.g., a photopolymerization initiator) is extremely high. In addition, the monomer has the following property: reactivity between a radicalized nitrogen-containing monomer and, for example, a (meth)acrylate, such as the (meth)acrylic acid alkyl ester, is high, though reactivity between the molecules of the radicalized nitrogen-containing monomer is low.

Any other monomer except the (meth)acrylic acid alkyl ester and the nitrogen-containing monomer may be utilized in the first acrylic polymer to the extent that the object of the present invention is not impaired; provided that the first acrylic polymer is free of a constituent unit derived from a carboxyl group-containing monomer to be described later, or contains the unit at a ratio of 1 mass % or less. This is because when the first acrylic polymer contains the constituent unit derived from the carboxyl group-containing monomer at a ratio of more than 1 mass o, in a production process for the pressure-sensitive adhesive layer, a carboxyl group, for example, acts on the filler (e.g., a filler having a surface made of a metal), and hence the first acrylic polymer adheres to the filler so as to be entangled around the filler to deteriorate the dispersibility of the filler.

It is preferred that a monomer having a functional group having active hydrogen, such as a hydroxyl group, a sulfonate group, or an amino group, instead of a carboxyl group be also not used in the first acrylic polymer from the viewpoint of, for example, the dispersibility of the filler.

The second acrylic polymer contains at least a constituent unit derived from a (meth)acrylic acid alkyl ester, a constituent unit derived from a nitrogen-containing monomer, and a constituent unit derived from a carboxyl group-containing monomer.

The (meth)acrylic acid alkyl ester to be utilized in the second acrylic polymer is the same as that to be utilized in the first acrylic polymer, and hence detailed description thereof is omitted. As in the first acrylic polymer, the (meth)acrylic acid alkyl ester to be utilized in the second acrylic polymer is preferably a (meth)acrylic acid alkyl ester having an alkyl group having 4 to 12 carbon atoms, more preferably a (meth)acrylic acid alkyl ester having an alkyl group having 4 to 8 carbon atoms.

In addition, the nitrogen-containing monomer to be utilized in the second acrylic polymer is the same as that to be utilized in the first acrylic polymer, and hence detailed description thereof is omitted. As in the first acrylic polymer, the nitrogen-containing monomer to be utilized in the second acrylic polymer is preferably N-vinyl-2-pyrrolidone (NVP) or N-vinyl-ε-caprolactam (NVC), particularly preferably N-vinyl-2-pyrrolidone (NVP).

In addition, a compound that has at least one carboxyl group and contains a polymerizable unsaturated bond is utilized as the carboxyl group-containing monomer to be utilized in the second acrylic polymer. Examples of such carboxyl group-containing monomer include (meth)acrylic acid, itaconic acid, maleic acid, fumaric acid, crotonic acid, and isocrotonic acid. Acid anhydrides of those carboxyl group-containing monomers (e.g., acid anhydride group-containing monomers, such as maleic anhydride and itaconic anhydride) may each also be used as the carboxyl group-containing monomer. The carboxyl group-containing monomers may be used alone or in combination thereof. The carboxyl group-containing monomer is preferably acrylic acid, methacrylic acid, or itaconic acid, particularly preferably acrylic acid.

Any other monomer except the (meth)acrylic acid alkyl ester, the nitrogen-containing monomer, and the carboxyl group-containing monomer may be utilized in the second acrylic polymer to the extent that the object of the present invention is not impaired. Such other monomer is, for example, a polyfunctional monomer.

The polyfunctional monomer includes a monomer having two or more polymerizable functional groups. Examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, and urethane acrylate. Those polyfunctional monomers may be used alone or in combination thereof.

The other monomer except the polyfunctional monomer is not particularly limited, and examples thereof include: (meth)acrylic acid alkoxyalkyl esters, such as 2-methoxyethyl (meth)acrylate, 2-ethoxyethyl (meth) acrylate, methoxytriethylene glycol (meth)acrylate, 3-methoxypropyl (meth)acrylate, 3-ethoxypropyl (meth)acrylate, 4-methoxybutyl (meth)acrylate, and 4-ethoxybutyl (meth)acrylate; (meth)acrylic)acrylic acid esters each having an alicyclic hydrocarbon group, such as cyclopentyl (meth)acrylate, cyclohexyl (meth)acrylate, and isobornyl (meth)acrylate; (meth)acrylic acid aryl esters, such as phenyl (meth)acrylate; vinyl esters, such as vinyl acetate and vinyl propionate; aromatic vinyl compounds, such as styrene and vinyltoluene; olefins or dienes, such as ethylene, butadiene, isoprene, and isobutylene; vinyl ethers, such as a vinyl alkyl ether; and vinyl chloride. Those monomers may be used alone or in combination thereof.

In the acrylic polymer, the ratio (mass ratio) of the constituent unit derived from the carboxyl group-containing monomer to the constituent unit derived from the nitrogen-containing monomer is 0.01 or more, preferably 0.1 or more, and is 40 or less, preferably 20 or less, more preferably 10 or less, still more preferably 0.8 or less. When the ratio falls within such range, an improvement in pressure-sensitive adhesive strength and a reduction in VOC production amount can be achieved.

The acrylic polymer contains preferably 50 mass % or more, more preferably 55 mass % or more, still more preferably 60 mass % or more of the constituent unit derived from the (meth)acrylic acid alkyl ester, and contains preferably 99 mass % or less, more preferably 98 mass % or less, still more preferably 97 mass % or less of the unit. When the content of the constituent unit derived from the (meth)acrylic acid alkyl ester in the acrylic polymer falls within such range, followability to an adherend can be secured and a pressure-sensitive adhesive characteristic can be improved.

The acrylic polymer contains preferably 1 mass % or more, more preferably 5 mass % or more, still more preferably 15 mass % or more of the constituent unit derived from the nitrogen-containing monomer, and contains preferably 50 mass % or less, more preferably 30 mass % or less, still more preferably 20 mass % or less of the unit. When the content of the constituent unit derived from the nitrogen-containing monomer in the acrylic polymer falls within such range, an improvement in pressure-sensitive adhesive strength and a reduction in VOC production amount can be achieved.

The acrylic polymer contains preferably 0.1 mass % or more, more preferably 1 mass % or more, still more preferably 2 mass % or more of the constituent unit derived from the carboxyl group-containing monomer, and contains preferably 30 mass % or less, more preferably 10 mass % or less, still more preferably 5 mass % or less of the unit. When the content of the constituent unit derived from the carboxyl group-containing monomer in the acrylic polymer falls within such range, an improvement in pressure-sensitive adhesive strength and a reduction in VOC production amount can be achieved.

In the acrylic polymer, the ratio (mass ratio) of the constituent unit derived from the carboxyl group-containing monomer to the constituent unit derived from the nitrogen-containing monomer is preferably 0.01 or more, more preferably 0.05 or more, still more preferably 0.1 or more, and is preferably 40 or less, more preferably 10 or less, still more preferably 0.8 or less. When the ratio falls within such range, an improvement in pressure-sensitive adhesive strength and a reduction in VOC production amount can be achieved.

The acrylic polymer contains preferably 0.001 mass % or more, more preferably 0.01 mass % or more, still more preferably 0.02 mass % or more of the constituent unit derived from the polyfunctional monomer, and contains preferably 1 mass % or less, more preferably 0.1 mass % or less, still more preferably 0.05 mass % or less of the unit. When the content of the constituent unit derived from the polyfunctional monomer in the acrylic polymer falls within such range, the cohesive strength of the pressure-sensitive adhesive layer does not become too large and a pressure-sensitive adhesive strength can be improved.

The acrylic polymer may be prepared by using a known or commonly used polymerization method. Examples of the polymerization method include a solution polymerization method, an emulsion polymerization method, a bulk polymerization method, and a photopolymerization method. Of those, a curing reaction based on heat or an active energy ray (e.g., UV light) involving using a polymerization initiator, such as a thermal polymerization initiator or a photopolymerization initiator, is preferably utilized at the time of the preparation of the acrylic polymer from the viewpoint of, for example, the dispersibility of the filler (e.g., conductive particles). A curing reaction involving using the photopolymerization initiator is particularly preferably utilized because the reaction has advantages such as the shortening of a polymerization time.

For example, the acrylic polymer may be prepared by irradiating a monomer composition having blended therein the photopolymerization initiator with an active energy ray (e.g., UV light) to polymerize its monomers. In addition, at the time of the preparation of the acrylic polymer, any other component to be incorporated into the pressure-sensitive adhesive layer may be blended together with the polymerization initiator. A method of preparing the acrylic polymer involving using a solventless-type pressure-sensitive adhesive composition containing the monomer composition is described in detail in the section (Method of forming Pressure-sensitive Adhesive Layer) to be described later.

The polymerization initiators, such as the thermal polymerization initiator and the photopolymerization initiator, to be utilized in the preparation of the acrylic polymer may be used alone or in combination thereof.

Examples of the thermal polymerization initiator include: azo-based polymerization initiators (e.g., 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, and 2,2′-azobis(N,N′-dimethyleneisobutylamidine) dihydrochloride); peroxide-based polymerization initiators (e.g., dibenzoyl peroxide, t-butyl permaleate, and lauroyl peroxide); and redox-based polymerization initiators. The usage amount of the thermal polymerization initiator is not particularly limited, and only needs to fall within a conventional range that enables the utilization as the thermal polymerization initiator.

Examples of the photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, and an acylphosphine oxide-based photopolymerization initiator.

Examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (manufactured by BASF, product name: IRGACURE 651), and anisole methyl ether. Examples of the acetophenone-based photopolymerization initiator include 1-hydroxycyclohexyl phenyl ketone (manufactured by BASF, product name: IRGACURE 184), 4-phenoxydichloroacetophenone, 4-t-butyl-dichloroacetophenone, 1-[4-(2-hydroxyethoxy)-phenyl]-2-hydroxy-2-methyl-1-propan-1-one (manufactured by BASF, product name: IRGACURE 2959), 2-hydroxy-2-methyl-1-phenyl-propan-1-one (manufactured by BASF, product name: DAROCUR 1173), and methoxyacetophenone. Examples of the α-ketol-based photopolymerization initiator include 2-methyl-2-hydroxypropiophenone and 1-[4-(2-hydroxyethyl)-phenyl]-2-hydroxy-2-methylpropan-1-one.

An example of the aromatic sulfonyl chloride-based photopolymerization initiator is 2-naphthalenesulfonyl chloride.

An example of the photoactive oxime-based photopolymerization initiator is 1-phenyl-1,1-propanedione-2-(o-ethoxycarbonyl)-oxime. An example of the benzoin-based photopolymerization initiator is benzoin. An example of the benzil-based photopolymerization initiator is benzil. Examples of the benzophenone-based photopolymerization initiator include benzophenone, benzoylbenzoic acid, 3,3′-dimethyl-4-methoxybenzophenone, polyvinylbenzophenone, and α-hydroxycyclohexyl phenyl ketone. An example of the ketal-based photopolymerization initiator is benzyl dimethyl ketal. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone.

Examples of the acylphosphine oxide-based photopolymerization initiator include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

Although the usage amount of the photopolymerization initiator is not particularly limited as long as the acrylic polymer can be formed by a photopolymerization reaction, for example, the usage amount is preferably 0.01 part by mass or more, more preferably 0.03 part by mass or more, still more preferably 0.05 part by mass or more with respect to 100 parts by mass of all monomer components to be utilized for forming the acrylic polymer, and is preferably 5 parts by mass or less, more preferably 3 parts by mass or less, still more preferably 2 parts by mass or less with respect thereto. When the usage amount of the photopolymerization initiator falls within such range, the polymerization reaction can be sufficiently performed, and hence a reduction in molecular weight of the polymer to be produced can be suppressed.

An active energy ray is utilized at the time of the activation of the photopolymerization initiator. Examples of such active energy ray include: ionizing radiations, such as an α-ray, a β-ray, a γ-ray, a neutron beam, and an electron beam; and UV light. Of those, UV light is particularly suitable. In addition, the irradiation energy, irradiation time, irradiation method, and the like of the active energy ray are not particularly limited, and only need to be such that the photopolymerization initiator is activated to cause a reaction between the monomer components.

(Filler)

For example, conductive particles for imparting conductivity to the pressure-sensitive adhesive layer are utilized as the filler.

Particles each having conductivity, such as metal powder, are utilized as the conductive particles. Examples of materials to be utilized in the conductive particles include conductive materials including: metals, such as nickel, iron, chromium, cobalt, aluminum, antimony, molybdenum, copper, silver, platinum, and gold; alloys, such as solder and stainless steel; metal oxides; and carbon, such as carbon black. The conductive particles may be particles (powder) each formed of any such conductive material as described in the foregoing, or may be metal-coated particles obtained by coating the surfaces of particles, such as polymer particles, glass particles, or ceramic particles, with a metal. In addition, particles obtained by coating the surfaces of metal particles with any other metal may be used as the conductive particles.

The shapes of the conductive particles include various shapes, such as a spherical shape, a flake shape (thin section shape), a spike shape (burr-like shape), and a filament shape, and are appropriately selected from known shapes. The shapes of the conductive particles are preferably spherical shapes from the viewpoints of, for example, the securement of a pressure-sensitive adhesive strength and the ease with which the conductive particles form a conductive path in the pressure-sensitive adhesive layer.

A filler except the conductive particles (e.g., heat-conductive particles) may be used as the filler.

The true density of the filler is preferably more than 0 g/cm³ and less than 8 g/cm³. The use of such low-density particles as described above is suitable for maintaining a state in which the filler is suspended while maintaining a substantially uniform distribution by at least the time the pressure-sensitive adhesive composition is cured to provide a stable pressure-sensitive adhesive layer. For example, when the filler is formed only of a conductive material, the specific gravity of the conductive material is the true density. In contrast, when a metal coating is formed on the surface of each of nonconductive particles like the above-mentioned metal-coated particles, the true density of the filler is determined by the following method. When the true density of the filler cannot be measured by the following method, the true density only needs to be measured by appropriately using a conventionally known method of measuring a true density.

Here, description is given by taking a filler obtained by coating the surface of a spherical glass bead (glass layer) 41 with silver (silver coating layer) 42 (conductive particles formed of so-called silver-coated glass particles) as an example of the filler 4. The true density of the filler 4 is calculated by using measured values obtained by: taking an image of the filler 4 with a scanning electron microscope (SEM); and measuring the particle diameter (radius R) of the filler 4, a thickness T of the silver coating layer 42, the particle diameter (radius r) of the glass layer 41, and the like from the resultant image (sectional SEM image). A method of calculating the true density is described in more detail below.

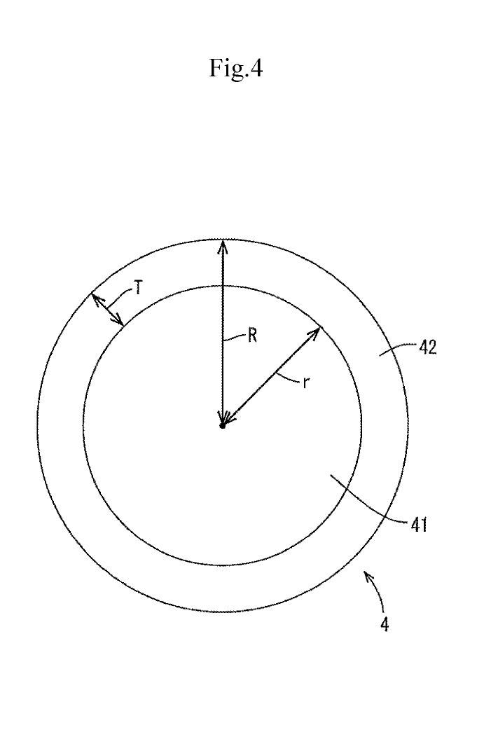

Here, description is given of taking the image of the filler 4 with the SEM. FIG. 4 is an explanatory view for schematically illustrating the sectional SEM image of the filler 4 to be used in the calculation of the true density of the filler 4. Before the image of the filler 4 is taken with the SEM, the adjustment of the filler 4 serving as a sample is performed in advance. Specifically, the filler 4 is stained with a heavy metal (heavy metal staining), and the stained filler 4 is subjected to ion milling processing and further subjected to a conductive treatment. The filler 4 adjusted as described above is observed (imaged) with the SEM. A section of the filler 4 is shown in the resultant SEM image.

For example, a product available under the product name “S-4800” from Hitachi, Ltd. may be used as the analyzer (SEM). In addition, the measurement conditions of the analyzer (SEM) are as follows: an observation image is a backscattered electron image and an acceleration voltage is 10 kV.

The thickness T of the silver coating layer 42 is measured by using the resultant sectional SEM image of the filler 4. Next, a volume v2 of the silver coating layer 42 per one particle of the filler 4 and a mass m2 of the silver coating layer 42 per one particle of the filler 4 are calculated by using the resultant thickness T (measured value) of the silver coating layer 42. At the time of the calculation, the specific gravity of silver (general literature value: 10 g/cm³) is used.

In addition, the particle diameter (radius r) of the glass layer 41 is measured by using the resultant sectional SEM image of the filler 4. Next, a volume v1 of the glass layer 41 per one particle of the filler 4 and a mass ml of the glass layer 41 per one particle of the filler 4 are calculated by using the resultant particle diameter (radius r, measured value) of the glass layer 41. At the time of the calculation, the specific gravity of glass (general literature value: 2.5 g/cm³) is used.

The particle diameter (radius r) of the glass layer 41 may be calculated from a measured value for the particle diameter (radius R) of the filler 4 and the measured value for the thickness T of the silver coating layer 42.

The true density of the filler 4 is calculated from the following equation by using the respective values v1, v2, m1, and m2 calculated as described above.

True density=(m1+m2)/(v1+v2)

Also in the case of a hollow filler (e.g., a filler in which the glass layer 41 is hollow), its true density may be determined by the above-mentioned calculation method.

In addition, the particle size distribution curve (particle diameter range, peak top, and the like) of the filler in the pressure-sensitive adhesive layer is determined in accordance with, for example, the following procedure.

First, the pressure-sensitive adhesive layer of the pressure-sensitive adhesive tape is baked, and the filler is extracted from the layer. A SEM image of the extracted filler is taken (at a magnification of, for example, 600 times), and the SEM image is subjected to computer image analysis with image analysis software (A-ZO KUN (trademark), manufactured by Asahi Kasei Engineering Corporation). Thus, particle information (particle diameter and the like) on the filler in the SEM image is acquired.

Although setting conditions for the image analysis (circular particle analysis) are not particularly limited, the analysis is performed under, for example, the following conditions: reduced scale value at the time of image transfer: 0.178571; brightness of a particle: bright; extraction method: automatic or manual; processing speed: high speed; noise-removing filter: present; unit in which a result is displayed: μm; range of diameters to be measured: 2 μm to 70 μm; circularity threshold: 10; and overlapping degree: 90. In addition, when a portion that is not particulate or a product in which particles adhere to each other is counted as one particle in analysis results, the particle diameter of each particle is determined by appropriately adding or deleting a particle through manual correction.

Such analysis as described above is performed at each of different positions of the SEM image a plurality of times (e.g., a total of 10 times), and the particle size distribution curve (particle diameter range, peak top, and the like) of the filler is determined from the average of the results.

The particle size distribution curve of the filler is determined by such image analysis as described above not only when the shape of the filler is a spherical shape but also when the shape is a shape except a spherical shape.

In this embodiment, for example, the particle diameter range of the filler starts from preferably 1 μm or more, more preferably 5 μm or more, still more preferably 10 μm or more, and ends on preferably 200 μm or less, more preferably 100 μm or less, still more preferably 80 μm or less, particularly preferably 50 μm or less. When the particle diameter range of the filler is such range, the functions, such as conductivity, of the pressure-sensitive adhesive layer can be secured without any reduction in pressure-sensitive adhesive strength of the pressure-sensitive adhesive layer.

In addition, the particle size distribution curve of the filler may be, for example, a curve having at least one peak top in the particle diameter range of from 15 μm or more to 50 μm or less, and having at least one peak top in the particle diameter range of from 1 μm or more to 12 μm or less.

In this embodiment, the filler is dispersed in the pressure-sensitive adhesive layer (pressure-sensitive adhesive resin) in a substantially uniform manner. Accordingly, as described later, the pressure-sensitive adhesive layer of the pressure-sensitive adhesive tape of this embodiment secures a sufficient pressure-sensitive adhesive strength and a sufficient function, such as conductivity.

In the pressure-sensitive adhesive layer, the content (mass ratio) of the filler to the pressure-sensitive adhesive resin (the acrylic polymer and the like) is preferably 0.1 or more, more preferably 0.3 or more, still more preferably 1.0 or more, and is preferably 3.0 or less, more preferably 2.5 or less, still more preferably 2 or less. When the ratio falls within such range, both a pressure-sensitive adhesive strength resulting from the pressure-sensitive resin and the functions, such as conductivity, of the filler can be achieved.

The volume fraction (vol %) of the filler in the pressure-sensitive adhesive layer is preferably 10 vol % or more, more preferably 20 vol % or more, still more preferably 30 vol % or more, and is preferably 70 vol % or less, more preferably 60 vol % or less, still more preferably 50 vol % or less. When the volume fraction (vol %) of the filler in the pressure-sensitive adhesive layer falls within such range, both the pressure-sensitive adhesive strength resulting from the pressure-sensitive resin and the functions, such as conductivity, of the filler can be achieved.

The pressure-sensitive adhesive layer may contain, as the pressure-sensitive adhesive resin, a pressure-sensitive adhesive, such as a rubber-based pressure-sensitive adhesive, a vinyl alkyl ether-based pressure-sensitive adhesive, a silicone-based pressure-sensitive adhesive, a polyester-based pressure-sensitive adhesive, a polyamide-based pressure-sensitive adhesive, a urethane-based pressure-sensitive adhesive, a fluorine-based pressure-sensitive adhesive, or an epoxy-based pressure-sensitive adhesive, to the extent that the object of the invention of the present application is not impaired. Those pressure-sensitive adhesives may be used alone or in combination thereof.

In addition, the pressure-sensitive adhesive layer may contain various tackifying resins, such as a hydrogenated tackifying resin, to the extent that the object of the invention of the present application is not impaired. For example, hydrogenated derivatives of tackifying resins, such as a petroleum-based resin, a terpene-based resin, a coumarone/indene-based resin, a styrene-based resin, a rosin-based resin, an alkylphenol resin, and a xylene resin, may each be used as the hydrogenated tackifying resin. For example, a hydrogenated petroleum-based resin is appropriately selected from aromatic-based, dicyclopentadiene-based, aliphatic-based, and aromatic-dicyclopentadiene copolymer-based resins and the like. In addition, a hydrogenated terpene-based resin is appropriately selected from a terpene phenol resin, an aromatic terpene resin, and the like. Those resins may be used alone or in combination thereof.

In addition, the pressure-sensitive adhesive layer may contain a cross-linking agent to the extent that the object of the invention of the present application is not impaired. The cross-linking agent may be utilized for the purpose of, for example, adjusting the cohesive strength of the pressure-sensitive adhesive layer. Examples of the cross-linking agent may include an epoxy-based cross-linking agent, an isocyanate-based cross-linking agent, a silicone-based cross-linking agent, an oxazoline-based cross-linking agent, an aziridine-based cross-linking agent, a silane-based cross-linking agent, an alkyl-etherified melamine-based cross-linking agent, and a metal chelate-based cross-linking agent. Those cross-linking agents may be used alone or in combination thereof.

In addition, the pressure-sensitive adhesive layer may contain, for example, a cross-linking promoter, a silane coupling agent, an age inhibitor, a colorant (such as a pigment or a dye), a UV absorber, an antioxidant, a chain transfer agent, a plasticizer, a softener, an antistatic agent, a solvent, a conductive fiber, or an oligomer having a weight-average molecular weight (Mw) of from 1,000 to 10,000 to the extent that the object of the invention of the present application is not impaired. Those additives may be used alone or in combination thereof.

(Method of Forming Pressure-Sensitive Adhesive Layer)

The pressure-sensitive adhesive layer to be utilized in the pressure-sensitive adhesive tape is formed by using, for example, a pressure-sensitive adhesive composition. The pressure-sensitive adhesive composition is not particularly limited as long as the above-mentioned pressure-sensitive adhesive layer of this embodiment can be formed of the composition, and the composition is appropriately selected in accordance with purposes. As an example, a curable pressure-sensitive adhesive composition containing a mixture of a monomer composition formed of the respective monomer components to be utilized for forming the acrylic polymer, a polymerization initiator for polymerizing the monomer components, the filler, and any other component to be added as required is preferably used as the pressure-sensitive adhesive composition from the viewpoint of, for example, workability.

The pressure-sensitive adhesive composition is particularly preferably a photocurable pressure-sensitive adhesive composition using a photopolymerization initiator as the polymerization initiator. The curable pressure-sensitive adhesive composition is a so-called solventless-type pressure-sensitive adhesive composition, and is prepared by mixing the monomer composition with the polymerization initiator and the like.

The curable pressure-sensitive adhesive composition after its preparation is applied onto an appropriate support, such as a base material or a release liner, in a layered manner. After that, the pressure-sensitive adhesive composition having a layer shape is subjected to a curing step. In addition, a drying step is performed as required before or after the curing step. When the pressure-sensitive adhesive composition contains a thermal polymerization initiator as the polymerization initiator, the polymerization reaction is initiated by heating to cure the pressure-sensitive adhesive composition. In contrast, when the pressure-sensitive adhesive composition contains a photopolymerization initiator as the polymerization initiator, the polymerization reaction is initiated by irradiation with light (active energy ray), such as UV light, to cure (photocure) the pressure-sensitive adhesive composition. When the pressure-sensitive adhesive composition is cured as described above, the pressure-sensitive adhesive layer that can be utilized in the pressure-sensitive adhesive tape is obtained.

In addition, in the application of the pressure-sensitive adhesive composition, a known or commonly used coating method may be used. For example, a general coater (e.g., agravure roll coater, a reverse roll coater, a kiss roll coater, a dip roll coater, a bar coater, a knife coater, a spray coater, a comma coater, or a direct coater) may be used.

In addition, the pressure-sensitive adhesive layer may be formed by utilizing a pressure-sensitive adhesive composition (e.g., a solvent-type pressure-sensitive adhesive composition or an emulsion-type pressure-sensitive adhesive composition) except the above-mentioned curable pressure-sensitive adhesive composition to the extent that the object of the invention of the present application is not impaired. However, the pressure-sensitive adhesive layer is preferably produced from the curable pressure-sensitive adhesive composition (so-called solventless-type pressure-sensitive adhesive composition) from, for example, the viewpoint that the occurrence of a volatile component is suppressed and the filler is securely and uniformly dispersed in the pressure-sensitive adhesive layer, and hence an excellent pressure-sensitive adhesive strength is obtained, and the layer is particularly preferably produced from the photocurable pressure-sensitive adhesive composition.

Here, as an example, a method of producing the pressure-sensitive adhesive tape involving utilizing the photocurable pressure-sensitive adhesive composition is described. The blending amounts of various components in the pressure-sensitive adhesive composition are appropriately set so as to be the above-mentioned contents of the various components in the pressure-sensitive adhesive layer.

In the method of producing the pressure-sensitive adhesive tape, the acrylic polymer forming the pressure-sensitive adhesive layer is polymerized in two stages, i.e., a first polymerization step and a second polymerization step. The acrylic polymer to be polymerized in the first polymerization step serving as a first stage is the first acrylic polymer, and the acrylic polymer to be polymerized in the second polymerization step serving as a second stage is the second acrylic polymer.

(First Polymerization Step)

The first polymerization step is a step of irradiating a monomer composition, which contains at least a (meth)acrylic acid alkyl ester having a linear or branched alkyl group having 1 to carbon atoms, a nitrogen-containing monomer, and a first photopolymerization initiator, with light to provide a syrupy monomer composition containing the first acrylic polymer obtained by the polymerization of part of the monomer composition through the irradiation.

The first photopolymerization initiator is a photopolymerization initiator to be utilized in the first polymerization step, and for example, the above-mentioned photopolymerization initiator is used.

Although the usage amount of the first photopolymerization initiator in the first polymerization step is not particularly limited as long as the first acrylic polymer can be formed by a photopolymerization reaction, for example, the usage amount is preferably 0.01 part by mass or more, more preferably 0.03 part by mass or more, still more preferably 0.05 part by mass or more with respect to 100 parts by mass of all the monomer components to be utilized for forming the acrylic polymer, and is preferably 5 parts by mass or less, more preferably 3 parts by mass or less, still more preferably 2 parts by mass or less with respect thereto. When the usage amount of the photopolymerization initiator falls within such range, the polymerization reaction can be sufficiently performed, and hence a reduction in molecular weight of the polymer to be produced can be suppressed.

In the first polymerization step, the monomer composition contains the monomers (the (meth)acrylic acid alkyl ester and the nitrogen-containing monomer) needed for the first acrylic polymer. The monomer composition also contains part of monomers needed for the second acrylic polymer in addition to the monomers needed for the first acrylic polymer.

In the first polymerization step, when the monomer composition is irradiated with light (active energy ray), such as UV light, the photopolymerization initiator is activated to generate a radical, and hence the polymerization (radical polymerization) of the monomers in the monomer composition is initiated.

In the first polymerization step, not all of the monomers in the monomer composition are polymerized, and part of the monomers are polymerized. The monomer composition in the first polymerization step is typically liquid, though the degree of its viscosity varies depending on, for example, the kinds and composition ratio of the monomer components. Accordingly, for the purpose of, for example, increasing the viscosity of the monomer composition to improve its workability (handleability), the monomer components in the monomer composition are partially polymerized to polymerize the first acrylic polymer. The monomer composition after the first polymerization step contains the first acrylic polymer and a monomer remaining without being utilized in the first polymerization step. The monomer remaining without being utilized in the first polymerization step is utilized at the time of the polymerization of the second acrylic polymer in the second polymerization step.

In the first polymerization step, for example, the amount (mass %) of the monomers to be utilized in the first acrylic polymer is preferably 5 mass % or more, more preferably 7 mass % or more with respect to the amount (mass %) of all the monomers in the monomer composition, and is preferably 15 mass % or less, more preferably 10 mass % or less with respect thereto. The polymerization rate of the first acrylic polymer may be appropriately regulated by, for example, grasping a correlation between the viscosity of the monomer composition and the polymerization rate of the first acrylic polymer in advance, and regulating the viscosity of the monomer composition on the basis of the correlation.

The nitrogen-containing monomer in the monomer composition has extremely high reactivity with a radical generated from a polymerization initiator. Accordingly, the radical generated from the photopolymerization initiator (first photopolymerization initiator) added to the monomer composition is considered to react mainly with the nitrogen-containing monomer. Reactivity between the molecules of a radicalized nitrogen-containing monomer is low, and hence the radicalized nitrogen-containing monomer is considered to selectively react with the (meth) acrylic acid alkyl ester. Then, a radicalized (meth)acrylic acid alkyl ester is considered to selectively react with the nitrogen-containing monomer. When the monomer composition contains some amount of the nitrogen-containing monomer as described above, reactivity between each of the monomers and the polymerization initiator is improved.

In the first polymerization step, it is preferred that the monomer composition be free of a carboxyl group-containing monomer or contain the monomer at a ratio of 1 mass % or less.

In the first polymerization step, when the monomer composition is free of the carboxyl group-containing monomer or contains the monomer at a ratio of 1 mass % or less, an interaction between the surface of a filler to be added later and a carboxyl group to be incorporated into the polymer reduces, and hence the filler is uniformly dispersed in a pressure-sensitive adhesive composition with ease without the deterioration of the flowability of the pressure-sensitive adhesive composition.

(Second Polymerization Step)

The second polymerization step is a step of irradiating the pressure-sensitive adhesive composition, which contains at least the syrupy monomer composition after the first polymerization step, the carboxyl group-containing monomer, the filler, and a polyfunctional monomer, with light to provide the second acrylic polymer obtained by the polymerization of at least the (meth)acrylic acid alkyl ester, the nitrogen-containing monomer, and the carboxyl group-containing monomer through the irradiation, and to provide such a pressure-sensitive adhesive layer that the filler is dispersed in a pressure-sensitive adhesive resin containing the first acrylic polymer and the second acrylic polymer.

In the second polymerization step, a second photopolymerization initiator may be further incorporated separately from the first photopolymerization initiator. The second photopolymerization initiator is a photopolymerization initiator to be utilized in the second polymerization step, and in the case of this embodiment, the initiator is formed of the same kind as that of the above-mentioned photopolymerization initiator. The same kind as that of the first photopolymerization initiator may be used as the second photopolymerization initiator, or a photopolymerization initiator of a kind different therefrom may be used as the initiator. The second polymerization step may be performed by utilizing the remaining first photopolymerization initiator.

Although the usage amount of the second photopolymerization initiator in the second polymerization step is not particularly limited as long as the second acrylic polymer can be formed by a photopolymerization reaction, for example, the usage amount is preferably 0.01 part by mass or more, more preferably 0.03 part by mass or more, still more preferably 0.05 part by mass or more with respect to 100 parts by mass of all the monomer components to be utilized for forming the acrylic polymer, and is preferably 5 parts by mass or less, more preferably 3 parts by mass or less, still more preferably 2 parts by mass or less with respect thereto. When the usage amount of the photopolymerization initiator falls within such range, the polymerization reaction can be sufficiently performed, and hence a reduction in molecular weight of the polymer to be produced can be suppressed.

In addition, the incorporation of the polyfunctional monomer into the pressure-sensitive adhesive composition can introduce a cross-linked structure into the acrylic polymer. Although the polyfunctional monomer may be added to the monomer composition in the first polymerization step, the monomer is preferably added to the pressure-sensitive adhesive composition in the second polymerization step in consideration of, for example, a moderate cohesive strength or pressure-sensitive adhesive strength of the pressure-sensitive adhesive layer, and the dispersibility of the filler.

In the second polymerization step, the pressure-sensitive adhesive composition is applied onto an appropriate support (e.g., a base material or a release liner) by using the above-mentioned known application method in a layered manner.

In the second polymerization step, when the pressure-sensitive adhesive composition is irradiated with light (active energy ray), such as UV light, the photopolymerization initiator is activated to generate a radical, and hence the polymerization (radical polymerization) of the monomers in the monomer composition is initiated. Also in the second polymerization step, the radical generated from the photopolymerization initiator is considered to preferentially (selectively) react with the nitrogen-containing monomer present in the pressure-sensitive adhesive composition.

As described above, the nitrogen-containing monomer has extremely high reactivity with a radical. Accordingly, even when the filler is added to the pressure-sensitive adhesive composition, the monomer can react with the photopolymerization initiator activated by the light with which the composition has been irradiated at a high probability. Accordingly, in the pressure-sensitive adhesive composition of the second polymerization step, the polymerization reaction efficiently advances and hence the amount of a remaining monomer reduces.

In addition, in the second polymerization step, the carboxyl group-containing monomer is added to the pressure-sensitive adhesive composition before the polymerization together with the filler. In the pressure-sensitive adhesive composition, the carboxyl group-containing monomer is not in the state of a polymer but in the state of a monomer. Accordingly, even when the carboxyl group-containing monomer adheres to the surface of the filler owing to an action of a carboxyl group, the dispersibility of the filler is not inhibited and hence the filler can be uniformly dispersed in the pressure-sensitive adhesive composition. When the carboxyl group-containing monomer is post-added to the syrupy monomer composition as described above, the thickening of the pressure-sensitive adhesive composition can be suppressed, and hence the viscosity of the pressure-sensitive adhesive composition can be controlled within such a range that the composition can be applied (e.g., 25 Pa·s or less). In addition, when the carboxyl group-containing monomer is post-added to the monomer composition, a problem such as steric hindrance at the time of its combined use with the nitrogen-containing monomer is reduced, and hence a monomer is less liable to remain.

The carboxyl group-containing monomer is taken in the second acrylic polymer in the second polymerization step to contribute to, for example, an improvement in pressure-sensitive adhesive strength of the pressure-sensitive adhesive layer (pressure-sensitive adhesive resin).

At the time of the formation of the pressure-sensitive adhesive layer, the irradiation with the light (active energy ray), such as UV light, may be performed from one surface side of the pressure-sensitive adhesive composition having a layer shape, or may be performed from both surface sides thereof. When the pressure-sensitive adhesive composition is cured as described above, the pressure-sensitive adhesive layer that can be utilized in the pressure-sensitive adhesive tape is obtained.

When the photoirradiation (photocuring) is performed, in order that the polymerization reaction may not be inhibited by oxygen in air, a known or commonly used oxygen-blocking method (e.g., the bonding of an appropriate support, such as a release liner or a base material, onto the pressure-sensitive adhesive composition (pressure-sensitive adhesive layer) having a layer shape, or the performance of a photocuring reaction under a nitrogen atmosphere) may be appropriately applied.

The pressure-sensitive adhesive layer obtained by such production method as described above may be separated into solvent-insoluble matter and solvent-soluble matter by using a solvent, such as ethyl acetate or toluene. At this time, the layer contains, as the solvent-insoluble matter, a large amount of the second acrylic polymer having added thereto the polyfunctional monomer and the like, and contains, as the solvent-soluble matter, a large amount of the first acrylic polymer. Accordingly, an acrylic acid amount in the solvent-insoluble matter is larger than an acrylic acid amount in the solvent-soluble matter. Alternatively, an acrylic acid amount in the entirety of the pressure-sensitive adhesive layer is larger than the acrylic acid amount in the solvent-soluble matter. Those acrylic acid amounts may be detected by NMR, an acid value, or the like.

(Thickness of Pressure-Sensitive Adhesive Layer)

Although the thickness (μm) of the pressure-sensitive adhesive layer is not particularly limited, for example, the thickness is preferably 15 μm or more, more preferably 20 μm or more, and is preferably 100 μm or less, more preferably 80 μm or less.

The thickness of the pressure-sensitive adhesive layer is measured with a dial gauge specified in JIS B 7503. Specifically, the contact surface of the dial gauge is a flat surface, and its diameter is set to, for example, 5 mm. Then, thicknesses at five points arranged at equal intervals in the widthwise direction of the pressure-sensitive adhesive layer are measured with a dial gauge having a scale of 1/1,000 mm, and the average of the measurement results is defined as the thickness of the pressure-sensitive adhesive layer.

When the pressure-sensitive adhesive tape includes two pressure-sensitive adhesive layers, the thicknesses of the layers may be identical to each other, or may be different from each other.

(Base Material)

A base material is a member configured to support the pressure-sensitive adhesive layer, and is not particularly limited. The base material is appropriately selected from known base materials in accordance with purposes. The base material is, for example, a conductive base material having conductivity to be utilized in a conductive pressure-sensitive adhesive tape.

The conductive base material includes a thin base material having conductivity, such as a metal foil. The conductive base material is not particularly limited as long as the base material can support the pressure-sensitive adhesive layer and has conductivity, and the base material is appropriately selected in accordance with purposes. The conductive base material is preferably the metal foil. Examples of materials for the metal foil to be utilized as the conductive base material include copper, aluminum, nickel, silver, iron, lead, and an alloy thereof. Of those, an aluminum foil or a copper foil is preferred, and a copper foil is more preferred, from the viewpoints of, for example, conductivity, processability, and cost. The metal foil may be subjected to various surface treatments, such as tin plating, silver plating, and gold plating. The metal foil is preferably a copper foil (tin-coated copper foil) having applied thereto a coating by tin plating because of, for example, the following reason: the tin-coated copper foil suppresses a reduction in conductivity, an unsatisfactory external appearance, and the like due to corrosion.

A base material except the conductive base material (e.g., a plastic base material) may be utilized as the base material.

Although the thickness of the base material is not particularly limited, for example, the thickness is preferably 5 μm or more, more preferably 8 μm or more, still more preferably 10 μm or more, and is preferably 200 μm or less, more preferably 150 μm or less, still more preferably 100 μm or less. When the thickness of the base material falls within such range, the strength of the pressure-sensitive adhesive tape is sufficiently secured, and hence workability at the time of its processing, bonding, or the like is improved.

(Release Liner)

The pressure-sensitive adhesive tape may include a release liner for protecting a pressure-sensitive adhesive surface of each pressure-sensitive adhesive layer until the time of its use. Such release liner is not particularly limited, and a release liner appropriately selected from known release liners may be used.

Examples of the release liner include: a base material including a release layer, such as a plastic film or paper, having a surface treated with a release agent based on, for example, a silicone, a long chain alkyl, fluorine, or molybdenum sulfide; a low adhesive base material formed of a fluorine-based polymer, such as polytetrafluoroethylene, polychlorotrifluoroethylene, polyvinyl fluoride, polyvinylidene fluoride, a tetrafluoroethylene-hexafluoropropylene copolymer, or a chlorofluoroethylene-vinylidene fluoride copolymer; and a low adhesive base material formed of a non-polar polymer, such as an olefin-based resin (e.g., polyethylene or polypropylene).

(Pressure-Sensitive Adhesive Strength)

In the pressure-sensitive adhesive tape, the pressure-sensitive adhesive strength (N/25 mm) of the pressure-sensitive adhesive layer is preferably 8 N/25 mm or more, more preferably 10 N/25 mm or more. Although an upper limit for the pressure-sensitive adhesive strength of the pressure-sensitive adhesive layer is not particularly limited, the pressure-sensitive adhesive strength is set to, for example, 30 N/25 mm or less. The pressure-sensitive adhesive strength of the pressure-sensitive adhesive layer is measured by a 180° peel test in conformity with JIS Z 0237 to be described later.

(Conductivity)

When the pressure-sensitive adhesive tape is a conductive pressure-sensitive adhesive tape, the pressure-sensitive adhesive layer has a resistance value in a Z-axis direction (thickness direction) of, for example, 100 mQ or less, preferably 20 mQ or less. In addition, the pressure-sensitive adhesive layer has a resistance value in X- and Y-axis directions (plane directions) of 10 Q or less, preferably 6 Q or less. Methods of measuring the resistance value in the Z-axis direction (thickness direction) of the pressure-sensitive adhesive layer, and the resistance value in the X- and Y-axis directions (plane directions) thereof are described later.

(VOC Production Amount)

The amount of a volatile organic compound (VOC) to be produced from the pressure-sensitive adhesive layer of the pressure-sensitive adhesive tape is 4,000 μg/g or less, preferably 3,500 μg/g or less, more preferably 1,000 μg/g or less, still more preferably 800 μg/g or less. As described above, the pressure-sensitive adhesive tape is suppressed in occurrence of the VOC. A method of measuring the VOC production amount is described later.

(Applications)

When the pressure-sensitive adhesive tape is a conductive pressure-sensitive adhesive tape, the tape can be used in grounding (earthing) applications, such as the grounding of a printed wiring board, the grounding of the outer package shield case of electronic equipment, and grounding for static protection. In addition, the conductive pressure-sensitive adhesive tape can also be used in applications such as the internal wiring of, for example, a power supply apparatus or electronic equipment (e.g., a portable information terminal, a display apparatus, such as a liquid crystal display apparatus, an organic electroluminescence (EL) display apparatus, a plasma display panel (PDP), or electronic paper, or a solar cell). In addition, the conductive pressure-sensitive adhesive tape can also be used in, for example, an application where two sites distant from each other are electrically connected, and electromagnetic shielding applications for electrical and electronic equipment, and cables.

In addition, the conductive pressure-sensitive adhesive tape can be suitably used in, for example, small electronic and electrical equipment (e.g., a portable information terminal, a smart phone, a tablet terminal, a cellular phone, or a car navigation system). In addition, the conductive pressure-sensitive adhesive tape can be utilized in an electronic member. Examples of the electronic member include a wiring board (e.g., a FPC or a rigid circuit board), a camera, a CPU, a driver circuit, an antenna, and a reinforcing plate for a wiring board.

In addition, the pressure-sensitive adhesive tape can also be used in applications except the conductive pressure-sensitive adhesive tape. For example, when the pressure-sensitive adhesive tape contains heat-conductive particles as its filler, the pressure-sensitive adhesive tape can be utilized in a heat conduction application, a heat radiation application, and the like.

As described above, the pressure-sensitive adhesive tape of this embodiment is suppressed in occurrence of a volatile organic component (VOC) and has an excellent pressure-sensitive adhesive strength.

(1) A filler-containing pressure-sensitive adhesive tape, including a pressure-sensitive adhesive layer containing a pressure-sensitive adhesive resin containing an acrylic polymer and a filler dispersed in the pressure-sensitive adhesive resin, in which the acrylic polymer contains at least a constituent unit derived from a (meth)acrylic acid alkyl ester having a linear or branched alkyl group having 1 to 20 carbon atoms, a constituent unit derived from a nitrogen-containing monomer, and a constituent unit derived from a carboxyl group-containing monomer, and has a ratio (mass ratio) of the constituent unit derived from the carboxyl group-containing monomer to the constituent unit derived from the nitrogen-containing monomer of from 0.01 to 40.

(2) The filler-containing pressure-sensitive adhesive tape according to Item (1), in which the acrylic polymer contains 1 mass % or more and 50 mass % or less of the constituent unit derived from the nitrogen-containing monomer.

(3) The filler-containing pressure-sensitive adhesive tape according to Item (1) or (2), in which a blending ratio (mass ratio) of the filler to the pressure-sensitive adhesive resin is from 0.1 to 3.

(4) The filler-containing pressure-sensitive adhesive tape according to any one of Items (1) to (3), in which a volume fraction (vol %) of the filler in the pressure-sensitive adhesive layer is from 10 vol % to 70 vol %.

(5) The filler-containing pressure-sensitive adhesive tape according to any one of Items (1) to (4), in which the filler has an average particle diameter of from 1 μm to 50 μm.

(6) The filler-containing pressure-sensitive adhesive tape according to any one of Items (1) to (5), in which the pressure-sensitive adhesive layer has a thickness of from 5 μm to 200 μm.

(7) The filler-containing pressure-sensitive adhesive tape according to any one of Items (1) to (6), in which the acrylic polymer has a first acrylic polymer containing at least the constituent unit derived from the (meth)acrylic acid alkyl ester, the constituent unit derived from the nitrogen-containing monomer, and the constituent unit derived from the carboxylic group-containing monomer and a second acrylic polymer containing at least the constituent unit derived from the (meth)acrylic acid alkyl ester, the constituent unit derived from the nitrogen-containing monomer, and the constituent unit derived from the carboxyl group-containing monomer.

(8) The filler-containing pressure-sensitive adhesive tape according to Item (7), in which the second acrylic polymer contains a constituent unit derived from a polyfunctional monomer having two or more polymerizable functional groups.

(9) The filler-containing pressure-sensitive adhesive tape according to any one of Items (1) to (8), in which the filler includes conductive particles.

(10) The filler-containing pressure-sensitive adhesive tape according to any one of Items (1) to (9), in which the acrylic polymer contains the constituent unit derived from the carboxyl group-containing monomer at a ratio of 0.1 mass % or more and 30 mass % or less.

(11) The filler-containing pressure-sensitive adhesive tape according to any one of Items (1) to (10), in which an amount of an acid in the pressure-sensitive adhesive layer is larger than an amount of an acid in the solvent-soluble matter of the pressure-sensitive adhesive layer.

(12) The filler-containing pressure-sensitive adhesive tape according to any one of Items (1) to (11), in which the acrylic polymer contains, as the (meth)acrylic acid alkyl ester, any one of n-butyl (meth)acrylate and 2-ethylhexyl (meth)acrylate.

(13) The filler-containing pressure-sensitive adhesive tape according to any one of Items (1) to (12), in which the filler has a core layer and a surface layer configured to cover the core layer, and the surface layer is formed of a metal layer.

(14) The filler-containing pressure-sensitive adhesive tape according to any one of Items (1) to (13), in which the filler has a core layer and a surface layer configured to cover the core layer, and the core layer and the surface layer are different from each other in composition.

(15) The filler-containing pressure-sensitive adhesive tape according to Item (13) or (14), in which the surface layer of the filler includes any one of Ag, Ni, Cu, and Au.

(16) The filler-containing pressure-sensitive adhesive tape according to any one of Items (13) to (15), in which the core layer of the filler includes any one of a polymer resin, glass, and ceramic.

(17) A method of producing the filler-containing pressure-sensitive adhesive tape of any one of Items (1) to (16), including a polymerization step of irradiating a composition, which contains at least a (meth)acrylic acid alkyl ester having a linear or branched alkyl group having 1 to 20 carbon atoms, a nitrogen-containing monomer, a carboxyl group-containing monomer, a filler, and a photopolymerization initiator, with light to provide such a pressure-sensitive adhesive layer that the filler is dispersed in a pressure-sensitive adhesive resin containing an acrylic polymer obtained by polymerization of the composition through the irradiation, in which in the polymerization step, a blending ratio (mass ratio) of the carboxyl group-containing monomer in the composition is from 0.01 to 40 with respect to a total amount of the nitrogen-containing monomer.

(18) The method of producing the filler-containing pressure-sensitive adhesive tape according to any one of Items (1) to (17), in which in the polymerization step, a blending ratio of the nitrogen-containing monomer in the composition is 1 mass % or more and 50 mass % or less with respect to a total amount (100 mass %) of the monomers.

(19) The method of producing the filler-containing pressure-sensitive adhesive tape according to Item (17) or (18), in which: the polymerization step includes a first polymerization step of irradiating a monomer composition, which contains at least the (meth)acrylic acid alkyl ester, the nitrogen-containing monomer, and the photopolymerization initiator, with light to provide a syrupy monomer composition containing a first acrylic polymer obtained by polymerization of part of the monomer composition through the irradiation, and a second polymerization step of irradiating a pressure-sensitive adhesive composition, which contains at least the syrupy monomer composition after the first polymerization step, the carboxyl group-containing monomer, the filler, and a polyfunctional monomer, with light to provide a second acrylic polymer obtained by polymerization of at least the (meth)acrylic acid alkyl ester, the nitrogen-containing monomer, and the carboxyl group-containing monomer through the irradiation, and to provide such a pressure-sensitive adhesive layer that the filler is dispersed in a pressure-sensitive adhesive resin containing the first acrylic polymer and the second acrylic polymer; and in the second polymerization step, a blending ratio (mass ratio) of the carboxyl group-containing monomer in the pressure-sensitive adhesive composition is from 0.01 to 40 with respect to a total amount of the nitrogen-containing monomer utilized in the polymerization of the first acrylic polymer and the polymerization of the second acrylic polymer.

The present invention is described in more detail below by way of Examples. The present invention is by no means limited by these Examples.

### EXAMPLE 1

### (Production of Syrup Composition A)

A liquid monomer mixture (monomer composition) obtained by mixing 84 parts by mass of 2-ethylhexyl acrylate (2EHA) and 16 parts by mass of N-vinyl-2-pyrrolidone (NVP) serving as monomer components was blended with 0.05 part by mass of a photopolymerization initiator available under the product name “IRGACURE 651 (2,2-dimethoxy-1,2-diphenylethan-1-one)” (manufactured by BASF Japan Ltd.) and 0.05 part by mass of a photopolymerization initiator available under the product name “IRGACURE 184 (1-hydroxycyclohexyl phenyl ketone)” (manufactured by BASF Japan Ltd.). After that, the resultant was irradiated with UV light until its viscosity (viscometer: manufactured by TOKIMEC, VISCOMETER (model: BH)) became about 6.4 Pa·s. Thus, a syrup composition A (2EHA/NVP=84/16) containing a partial polymer (prepolymer) obtained by the polymerization of part of the monomer components through the irradiation was obtained.

(Production of Pressure-Sensitive Adhesive Composition)

The syrup composition A was blended with 3 parts by mass of acrylic acid (AA), 0.05 part by mass of 1,6-hexanediol diacrylate (HDDA), 150 parts by mass of conductive particles (product name: “TP25S12”, manufactured by Potters-Ballotini Co., Ltd., silver-coated glass powder, particle diameter corresponding to the peak top of a particle size distribution curve: 26 μm, particle diameter range: 18 μm to 35 μm, true density: 2.7 g/cm³), 50 parts by mass of conductive particles (product name: “ES-6000-S7N”, manufactured by Potters-Ballotini Co., Ltd., silver-coated glass powder, particle diameter corresponding to the peak top of a particle size distribution curve: 6 μm, particle diameter range: 2 μm to 10 μm, true density: 3.9 g/cm³), and 0.05 parts by mass of a photopolymerization initiator available under the product name “IRGACURE 651 (2,2-dimethoxy-1,2-diphenylethan-1-one)” (manufactured by BASF Japan Ltd.), and the syrup composition and the foregoing materials were sufficiently mixed to provide a pressure-sensitive adhesive composition.

(Production of Pressure-Sensitive Adhesive Tape)

The pressure-sensitive adhesive composition was applied onto the release-treated surface of a release liner to form an applied layer on the release liner. Then, another release liner was bonded onto the applied layer so that its release-treated surface was brought into contact therewith. Thus, the release liners were bonded to each other so that the applied layer was sandwiched therebetween. Polyethylene terephthalate base materials (product name: “MRE”, thickness: 38 μm, manufactured by Mitsubishi Polyester Film Inc.; product name: “MRF”, thickness: 38 μm, manufactured by Mitsubishi Polyester Film Inc.) having the following feature were used as the release liners: one surface of each of the base materials was subjected to a release treatment.

Next, both surfaces of the applied layer were irradiated with UV light having an irradiance of 5 mW/cm² for 3 minutes. Thus, the applied layer was cured to provide a pressure-sensitive adhesive layer having a thickness of 50 μm. “BLACK LIGHT” manufactured by Toshiba Corporation was used as the emission source of the UV light. In addition, the irradiance of the UV light was regulated with a UV checker (product name: “UVR-T1”, manufactured by Topcon Corporation, maximum sensitivity: measured at 350 nm).

Thus, a pressure-sensitive adhesive tape of Example 1 (base material-less double-sided pressure-sensitive adhesive tape having a laminated structure “release liner/pressure-sensitive adhesive layer/release liner”) was obtained.

The thickness of the pressure-sensitive adhesive layer was measured with a dial gauge specified in JIS B 7503. The contact surface of the dial gauge was a flat surface, and its diameter was set to 5 mm. A test piece having a width of 150 mm was used, and thicknesses at five points arranged at equal intervals in its widthwise direction were measured with a dial gauge having a scale of 1/1,000 mm. The average of the measurement results was defined as the thickness of the pressure-sensitive adhesive layer. The thicknesses of pressure-sensitive adhesive layers in the subsequent Examples and Comparative Examples were similarly determined.

### EXAMPLE 2

A pressure-sensitive adhesive tape of Example 2 (thickness of a pressure-sensitive adhesive layer: 50 μm) was produced in the same manner as in Example 1 except that the blending amount of acrylic acid (AA) was changed to 5 parts by mass.

### EXAMPLE 3

A pressure-sensitive adhesive tape of Example 3 (thickness of a pressure-sensitive adhesive layer: 50 μm) was produced in the same manner as in Example 1 except that the blending amount of acrylic acid (AA) was changed to 10 parts by mass.

### EXAMPLE 4

A syrup composition B (2EHA/NVC=92/8) was produced in the same manner as in Example 1 except that: the blending amount of 2-ethylhexyl acrylate (2EHA) was changed to 92 parts by mass; and N-vinyl-2-pyrrolidone (NVP) was changed to 8 parts by mass of N-vinyl-ε-caprolactam (NVC). A pressure-sensitive adhesive tape of Example 4 (thickness of a pressure-sensitive adhesive layer: 50 μm) was produced in the same manner as in Example 1 except that: the syrup composition B was used instead of the syrup composition A; and the blending amount of acrylic acid (AA) was changed to 5 parts by mass.

### COMPARATIVE EXAMPLE 1

A syrup composition C (2EHA/NVP=100/0) was produced in the same manner as in Example 1 except that: the blending amount of 2-ethylhexyl acrylate (2EHA) was changed to 100 parts by mass; and N-vinyl-2-pyrrolidone (NVP) was not blended (blending amount: 0). A pressure-sensitive adhesive tape of Comparative Example 1 (thickness of a pressure-sensitive adhesive layer: 50 μm) was produced in the same manner as in Example 1 except that: the syrup composition C was used instead of the syrup composition A; and acrylic acid (AA) was not blended (blending amount: 0).

### COMPARATIVE EXAMPLE 2

A syrup composition D (2EHA/NVP=96/4) was produced in the same manner as in Example 1 except that: the blending amount of 2-ethylhexyl acrylate (2EHA) was changed to 96 parts by mass; and the blending amount of N-vinyl-2-pyrrolidone (NVP) was changed to 4 parts by mass. A pressure-sensitive adhesive tape of Comparative Example 2 (thickness of a pressure-sensitive adhesive layer: 50 μm) was produced in the same manner as in Example 1 except that: the syrup composition D was used instead of the syrup composition A; and acrylic acid (AA) was not blended (blending amount: 0).

### COMPARATIVE EXAMPLE 3

A syrup composition E (2EHA/NVP=92/8) was produced in the same manner as in Example 1 except that: the blending amount of 2-ethylhexyl acrylate (2EHA) was changed to 92 parts by mass; and the blending amount of N-vinyl-2-pyrrolidone (NVP) was changed to 8 parts by mass. A pressure-sensitive adhesive tape of Comparative Example 3 (thickness of a pressure-sensitive adhesive layer: 50 μm) was produced in the same manner as in Example 1 except that: the syrup composition E was used instead of the syrup composition A; and acrylic acid (AA) was not blended (blending amount: 0).

### COMPARATIVE EXAMPLE 4

A pressure-sensitive adhesive tape of Comparative Example 4 (thickness of a pressure-sensitive adhesive layer: 50 μm) was produced in the same manner as in Example 1 except that acrylic acid (AA) was not blended (blending amount: 0).

### COMPARATIVE EXAMPLE 5

A pressure-sensitive adhesive tape of Comparative Example 5 (thickness of a pressure-sensitive adhesive layer: 50 μm) was produced in the same manner as in Example 1 except that: acrylic acid (AA) was not blended (blending amount: 0); the blending amount of the large-diameter conductive particles (silver-coated glass powder) was changed to 112.5 parts by mass; and the blending amount of the small-diameter conductive particles (silver-coated glass powder) was changed to 37.5 parts by mass.

### COMPARATIVE EXAMPLE 6

A pressure-sensitive adhesive tape of Comparative Example 6 (thickness of a pressure-sensitive adhesive layer: 50 μm) was produced in the same manner as in Example 1 except that: acrylic acid (AA) was not blended (blending amount: 0); the blending amount of the large-diameter conductive particles (silver-coated glass powder) was changed to 75 parts by mass; and the blending amount of the small-diameter conductive particles (silver-coated glass powder) was changed to 25 parts by mass.

### COMPARATIVE EXAMPLE 7

A pressure-sensitive adhesive tape of Comparative Example 7 (thickness of a pressure-sensitive adhesive layer: 50 μm) was produced in the same manner as in Example 1 except that: acrylic acid (AA) was not blended (blending amount: 0); the blending amount of the large-diameter conductive particles (silver-coated glass powder) was changed to 37.5 parts by mass; and the blending amount of the small-diameter conductive particles (silver-coated glass powder) was changed to 12.5 parts by mass.

[Various Characteristics]

The volume fraction of the filler, pressure-sensitive adhesive strength, transmittance, VOC production amount, resistance value (Z-axis direction), and resistance value (X- and Y-axis directions) of each of the pressure-sensitive adhesive tapes of Examples and Comparative Examples were measured by the following methods.

(Volume Fraction of Filler)

A test sample having a predetermined size was cut out of each of the resultant pressure-sensitive adhesive tapes. The test sample was subjected to FIB processing with a focused ion beam-scanning electron microscope (FIB-SEM) apparatus and a SEM image of a processed section thereof was taken with the apparatus; the procedure was repeated a plurality of times (200 images were taken at an interval of about 200 nm). Thus, a continuous sectional SEM image was obtained. Then, a three-dimensional reconstructed image (corresponding to a space measuring 83 μm wide by 64 μm long by 40 μm thick) was obtained from the continuous sectional SEM image by utilizing analysis software attached to the apparatus. After that, the three-dimensional reconstructed image was subjected to binarization processing into a filler and a parent material portion by utilizing image analysis software “Amira” (manufactured by Mercury Computer Systems), and then quantitative analysis was performed to calculate the volume fraction (vol %) of the filler in the test sample (pressure-sensitive adhesive layer). The results are shown in Table 1. An apparatus available under the product name “Helios Nanolab 600” (manufactured by FEI) was used as the FIB-SEM apparatus. In addition, the acceleration voltage of the FIB was set to 30 kV, and the acceleration voltage of the SEM was set to 1 kV.

(Pressure-Sensitive Adhesive Strength)

A measurement sample measuring 25 mm wide by 100 mm long was cut out of each of the resultant pressure-sensitive adhesive tapes. One pressure-sensitive adhesive surface of the pressure-sensitive adhesive layer of the sample was bonded to a SUS plate (SUS304 plate) by reciprocating a roller having a weight of 2.0 kg and a width of 30 mm once under an atmosphere at 23° C. and 60% RH. The other pressure-sensitive adhesive surface of the pressure-sensitive adhesive layer is in a state in which the release liner remains bonded thereto . After the resultant had been left to stand at normal temperature (23° C., 60% RH) for 30 minutes, a 180° peel test was performed with a tensile tester in conformity with JIS Z 0237 at a tensile rate of 300 mm/min to measure a peel pressure-sensitive adhesive strength (N/25 mm). The results are shown in Table 1.

(Transmittance)

A test sample having a predetermined size (20 mm wide by 40 mm long) was cut out of each of the resultant pressure-sensitive adhesive tapes. The transmittance of the test sample for light (UV light) having a wavelength of 355 nm was measured with an ultraviolet-visible spectrophotometer (UV-Vis apparatus). An apparatus available under the product name “UV-2550” (manufactured by Shimadzu Corporation) was used as the UV-Vis apparatus. The results are shown in Table 1.

(VOC Production Amount)

A test sample having an area of 10 cm² (20 mm wide by 50 mm long) was cut out of each of the resultant pressure-sensitive adhesive tapes. The test sample was loaded into a screw tube, and 5 mL of ethyl acetate was further loaded into the screw tube, followed by shaking extraction for 1 day. After that, the extract was filtered with a 0.45-micrometer membrane filter, and 1 μL of the filtrate was injected into a gas chromatograph, followed by the measurement of the mass of a produced gas. A value obtained by converting the resultant mass of the gas into a mass (μg) per 1 g of the pressure-sensitive adhesive tape (pressure-sensitive adhesive layer) was defined as a VOC production amount (μg/g). The results are shown in Table 1. The used gas chromatograph is an apparatus available under the product name “7890B” (manufactured by Agilent Technologies). In addition, measurement conditions are as described below.

Column: a column available under the product name “HP-1” (measuring 0.250 mm in inner diameter by 30 min length, thickness: 1.0 μm, manufactured by Agilent Technologies), column temperature: 300° C. (the temperature was kept at 40° C. for 3 minutes, then increased to 300° C. at 10° C/min, and further kept at 300° C. for 5 minutes), column flow rate: 1 mL/min (He), column pressure: 75 kPa (constant flow rate mode), injection port temperature: 250° C., injection amount: 1 μL, injection system: split (split ratio: 10:1), detector: a FID, detector temperature: 250° C.

(Resistance Value (Z-Axis Direction))

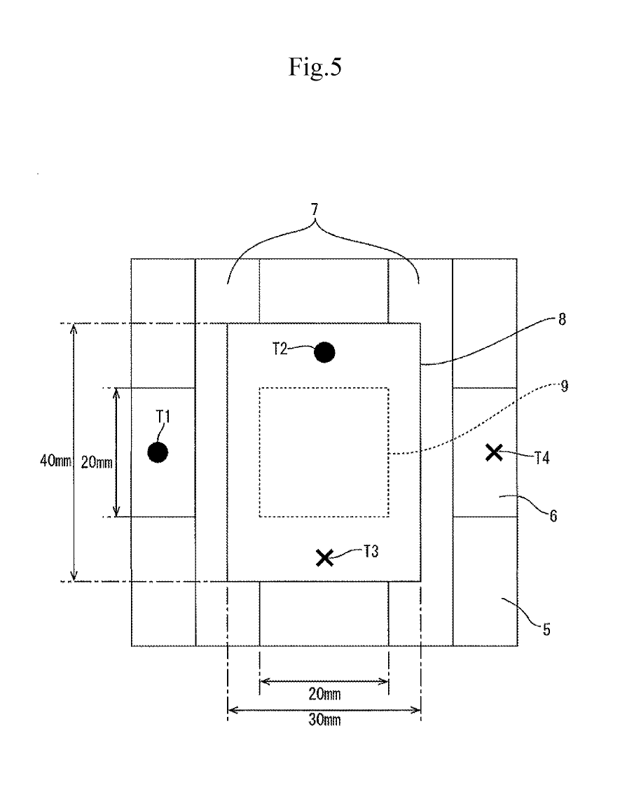

A copper foil (rolled copper foil, thickness: 35 μm) was bonded to each of the resultant pressure-sensitive adhesive tapes, and then a measurement sample measuring 30 mm wide by 40 mm long was cut out of the resultant. According to dimensions illustrated in FIG. 5, a copper foil (rolled copper foil, thickness: 35 μm) 6 was placed on a glass plate (soda lime glass) 5, insulating tapes 7 were superimposed on the copper foil 6, and the copper foil 6 and a measurement sample 8 were crimped with each other under a normal-temperature environment with a hand roller (width: 30 mm) at a pressure of 5.0 N/cm² so that the area of a bonding portion 9 (the inside of a region surrounded by broken lines in FIG. 5) became 4 cm². A longitudinal direction of FIG. 5 is a lengthwise direction of the measurement sample 8, and the sample was bonded so that a pressure-sensitive adhesive surface of the pressure-sensitive adhesive layer of the pressure-sensitive adhesive tape was brought into contact with the surface of the copper foil 6. After the bonding, the resultant was left to stand under a normal-temperature environment for 15 minutes, and then the terminals of a resistance meter (RM3544-01 manufactured by Hioki E.E. Corporation) were connected to the end portions of the copper foil (portions corresponding to marks represented by symbols T1 and T2 in FIG. 5) to measure the resistance value of the pressure-sensitive adhesive tape (pressure-sensitive adhesive layer) in its thickness direction (Z-axis direction). The results are shown in Table 1.

(Resistance Value (X- and Y-Axis Directions))

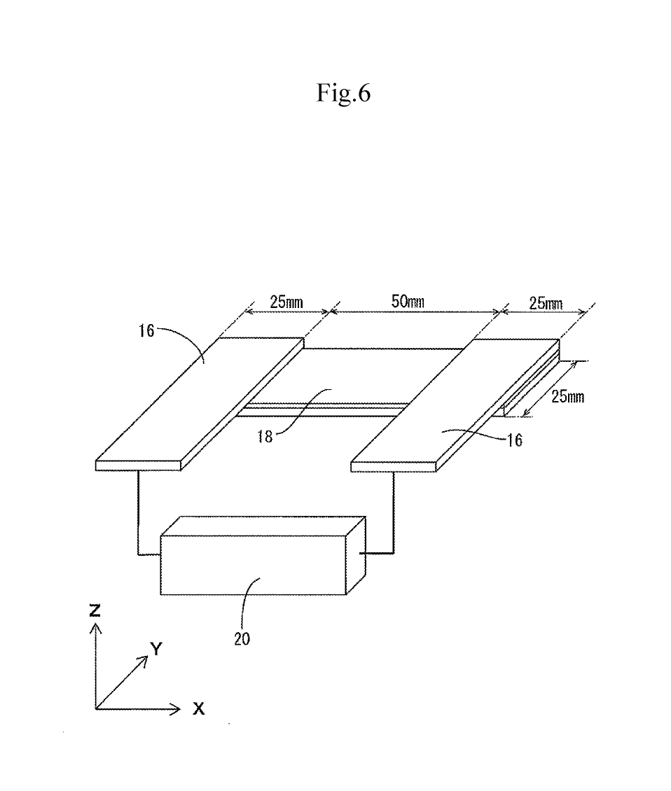

A measurement sample 18 measuring 25 mm wide by 100 mm long was cut out of each of the resultant pressure-sensitive adhesive tapes. Copper foils (rolled copper foils, thickness: 35 μm) 16 each having a width of 25 mm were bonded to both ends in a lengthwise direction in one pressure-sensitive adhesive surface of the pressure-sensitive adhesive layer of the sample as illustrated in FIG. 6, and a resistance value between the copper foils 16, 16 (resistance value of the pressure-sensitive adhesive tape (pressure-sensitive adhesive layer) in its plane directions (X- and Y-axis directions)) was measured by utilizing a measuring instrument (multimeter) 20. The results are shown in Table 1. The other pressure-sensitive adhesive surface of the pressure-sensitive adhesive layer is in a state in which the release liner remains bonded thereto.

TABLE 1

| | | Pressure-sensitive adhesive composition | | | | | | | |
|---|---|---|---|---|---|---|---|---|---|
| | | | | | | | | | Silver |
| | | | | | | | | | filler |
| | | | | | | | | | (formed of |
| | | Monomer composition | | | | Additional components | | | two kinds, |
| | | | | Resin components | | | Resin components | | i.e., a |
| | | | | (Meth)acrylic | | | CO₂H | | large filler |
| | | Initiator | | acid | Nitrogen- | Initiator | group- | Poly- | and a small |
| | | Irg | Irg | alkyl | containing | Irg | containing | functional | filler) |
| | | 184 | 651 | ester | monomer | 651 | monomer | monomer | (mass ratio) |
| Example | 1 | 0.05 | 0.05 | 2EHA | NVP | 0.05 | AA | HDDA | 200 |
| | | | | (84) | (16) | | (3) | (0.05) | |
| | 2 | 0.05 | 0.05 | 2EHA | NVP | 0.05 | AA | HDDA | 200 |
| | | | | (84) | (16) | | (5) | (0.05) | |
| | 3 | 0.05 | 0.05 | 2EHA | NVP | 0.05 | AA | HDDA | 200 |
| | | | | (84) | (16) | | (10) | (0.05) | |
| | 4 | 0.05 | 0.05 | 2EHA | NVC | 0.05 | AA | HDDA | 200 |
| | | | | (92) | (8) | | (5) | (0.05) | |
| Comparative | 1 | 0.05 | 0.05 | 2EHA | 0 | 0.05 | 0 | HDDA | 200 |
| Example | | | | (100) | | | | (0.05) | |
| | 2 | 0.05 | 0.05 | 2EHA | NVP | 0.05 | 0 | HDDA | 200 |
| | | | | (96) | (4) | | | (0.05) | |
| | 3 | 0.05 | 0.05 | 2EHA | NVP | 0.05 | 0 | HDDA | 200 |
| | | | | (92) | (8) | | | (0.05) | |
| | 4 | 0.05 | 0.05 | 2EHA | NVP | 0.05 | 0 | HDDA | 200 |
| | | | | (84) | (16) | | | (0.05) | |
| | 5 | 0.05 | 0.05 | 2EHA | NVP | 0.05 | 0 | HDDA | 150 |
| | | | | (84) | (16) | | | (0.05) | |
| | 6 | 0.05 | 0.05 | 2EHA | NVP | 0.05 | 0 | HDDA | 100 |
| | | | | (84) | (16) | | | (0.05) | |
| | 7 | 0.05 | 0.05 | 2EHA | NVP | 0.05 | 0 | HDDA | 50 |
| | | | | (84) | (16) | | | (0.05) | |
| | | Pressure- | | | | | | | |
| | | sensitive | | | | | | | |
| | | adhesive | | | | | | | |
| | | composition | | | | | | | |
| | | CO₂H | | | | | | | |
| | | group- | | Various characteristics of pressure-sensitive | | | | | |
| | | containing | | adhesive tape | | | | | |
| | | monomer/ | Silver | | Pressure- | | | | Resistance |
| | | nitrogen- | filler/ | | sensitive | | | Resistance | value |
| | | containing | resin | Filler | adhesive | | | value | (Ω) |
| | | monomer | components | concentration | strength | | | (Ω) | X- and |
| | | (mass | (mass | (vol | (N/25 | Transmittance | VOC | Z-axis | Y-axis |
| | | ratio) | ratio) | %) | mm) | (%) | (μg/g) | direction | directions |
| Example | 1 | 0.19 | 2 | 38 | 18.04 | 4.2 | 205 | 0.05 | 10 |
| | 2 | 0.31 | 2 | 38 | 22.27 | 4.2 | 230 | 0.02 | 10 |
| | 3 | 0.63 | 2 | 38 | 23.35 | 4.2 | 720 | 0.02 | 10 |
| | 4 | 0.63 | 2 | 38 | 14.80 | 4.2 | 3,470 | 0.04 | 10 |
| Comparative | 1 | — | 2 | 38 | 0.44 | 4.2 | 12,682 | 0.31 | 10 |
| Example | 2 | 0 | 2 | 38 | 1.67 | 4.2 | 1,300 | 0.07 | 10 |
| | 3 | 0 | 2 | 38 | 2.17 | 4.2 | 1,500 | 0.01 | 10 |
| | 4 | 0 | 2 | 38 | 5.17 | 4.2 | 160 | 0.09 | 10 |
| | 5 | 0 | 2 | 29 | 5.62 | 7.2 | 107 | 0.74 | 18 |
| | 6 | 0 | 1 | 20 | 6.12 | 22 | 80 | 0.81 | 3.0 × 10⁶ |
| | | | | | | | | | or more |
| | 7 | 0 | 0.5 | 10 | 6.33 | 40 | 64 | 0.84 | 3.0 × 10⁶ |
| | | | | | | | | | or more |

As shown in Table 1, it was confirmed that each of the pressure-sensitive adhesive tapes of Examples 1 to 4 had an excellent pressure-sensitive adhesive strength and was suppressed in production of a VOC. In addition, it was confirmed that the resistance values (the Z-axis direction, and the X- and Y-axis directions) of each of the pressure-sensitive adhesive tapes of Examples 1 to 4 were suppressed to low values, and hence the tapes were excellent in conductivity.

In contrast, in each of the pressure-sensitive adhesive tapes of Comparative Examples 1 to 7, acrylic acid serving as a carboxyl group-containing monomer was not added to the pressure-sensitive adhesive composition. Accordingly, the following results were obtained: the pressure-sensitive adhesive strengths of the resultant pressure-sensitive adhesive tapes (pressure-sensitive adhesive layers) were weak. The VOC production amounts of Comparative Examples 2 to 7 out of Comparative Examples 1 to 7 are suppressed to low values because the nitrogen-containing monomer is utilized for forming the acrylic polymers, though their pressure-sensitive adhesive strengths are weak. This is probably because the utilization of the nitrogen-containing monomer efficiently advanced the polymerization of the acrylic polymers to reduce the amounts of remaining monomers. The VOC production amounts of Examples 1 to 4 using the nitrogen-containing monomers are similarly suppressed to low values.

What is claimed is:

1. A filler-containing pressure-sensitive adhesive tape, comprising a pressure-sensitive adhesive layer containing a pressure-sensitive adhesive resin containing an acrylic polymer and a filler dispersed in the pressure-sensitive adhesive resin,
wherein the acrylic polymer contains at least a constituent unit derived from a (meth)acrylic acid alkyl ester having a linear or branched alkyl group having 1 to 20 carbon atoms, a constituent unit derived from a nitrogen-containing monomer, and a constituent unit derived from a carboxyl group-containing monomer, and has a ratio (mass ratio) of the constituent unit derived from the carboxyl group-containing monomer to the constituent unit derived from the nitrogen-containing monomer of from 0.01 to 40.

2. The filler-containing pressure-sensitive adhesive tape according to claim 1, wherein the acrylic polymer contains 1 mass % or more and 50 mass % or less of the constituent unit derived from the nitrogen-containing monomer.

3. The filler-containing pressure-sensitive adhesive tape according to claim 1, wherein a blending ratio (mass ratio) of the filler to the pressure-sensitive adhesive resin is from 0.1 to 3.

4. The filler-containing pressure-sensitive adhesive tape according to claim 1, wherein a volume fraction (vol %) of the filler in the pressure-sensitive adhesive layer is from 10 vol % to 70 vol % .

5. The filler-containing pressure-sensitive adhesive tape according to claim 1, wherein the filler has an average particle diameter of from 1 μm to 200 μm.

6. The filler-containing pressure-sensitive adhesive tape according to claim 1, wherein the pressure-sensitive adhesive layer has a thickness of from 5 μm to 200 μm.

7. The filler-containing pressure-sensitive adhesive tape according to claim 1, wherein the acrylic polymer has
a first acrylic polymer containing at least the constituent unit derived from the (meth)acrylic acid alkyl ester and the constituent unit derived from the nitrogen-containing monomer, and
a second acrylic polymer containing at least the constituent unit derived from the (meth)acrylic acid alkyl ester, the constituent unit derived from the nitrogen-containing monomer, and the constituent unit derived from the carboxyl group-containing monomer.

8. The filler-containing pressure-sensitive adhesive tape according to claim 7, wherein the second acrylic polymer contains a constituent unit derived from a polyfunctional monomer having two or more polymerizable functional groups.

9. The filler-containing pressure-sensitive adhesive tape according to claim 1, wherein the filler comprises conductive particles.

10. A method of producing the filler-containing pressure-sensitive adhesive tape of claim 1,
the method comprising a polymerization step of irradiating a composition, which contains at least a (meth)acrylic acid alkyl ester having a linear or branched alkyl group having 1 to 20 carbon atoms, a nitrogen-containing monomer, a carboxyl group-containing monomer, a filler, and a photopolymerization initiator, with light to provide such a pressure-sensitive adhesive layer that the filler is dispersed in a pressure-sensitive adhesive resin containing an acrylic polymer obtained by polymerization of the composition through the irradiation, wherein
in the polymerization step, a blending ratio (mass ratio) of the carboxyl group-containing monomer in the composition is from 0.01 to 40 with respect to a total amount of the nitrogen-containing monomer.

11. The method of producing the filler-containing pressure-sensitive adhesive tape according to claim 10, wherein:
the polymerization step includes
a first polymerization step of irradiating a monomer composition, which contains at least the (meth)acrylic acid alkyl ester, the nitrogen-containing monomer, and the photopolymerization initiator, with light to provide a syrupy monomer composition containing a first acrylic polymer obtained by polymerization of part of the monomer composition through the irradiation, and
a second polymerization step of irradiating a pressure-sensitive adhesive composition, which contains at least the syrupy monomer composition after the first polymerization step, the carboxyl group-containing monomer, the filler, and a polyfunctional monomer, with light to provide a second acrylic polymer obtained by polymerization of at least the (meth)acrylic acid alkyl ester, the nitrogen-containing monomer, and the carboxyl group-containing monomer through the irradiation, and to provide such a pressure-sensitive adhesive layer that the filler is dispersed in a pressure-sensitive adhesive resin containing the first acrylic polymer and the second acrylic polymer; and
in the second polymerization step, a blending ratio (mass ratio) of the carboxyl group-containing monomer in the pressure-sensitive adhesive composition is from 0.01 to 40 with respect to a total amount of the nitrogen-containing monomer utilized in the polymerization of the first acrylic polymer and the polymerization of the second acrylic polymer.
